(19) United States
(12) Patent Application Publication
(10) Pub. No.: US 2022/0075387 A1
(43) Pub. Date: Mar. 10, 2022

(54) ELECTRONIC DEVICE AND CONTROL METHOD THEREOF

(71) Applicant: SAMSONG ELECTRONICS CO., LTD., Suwon-si (KR)

(72) Inventors: Mideum CHOI, Suwon-si (KR); Aron BAIK, Suwon-si (KR); Yekeun JEONG, Busan (KR)

(73) Assignee: SAMSONG ELECTRONICS CO., LTD., Suwon-si (KR)

(21) Appl. No.: 17/417,314

(22) PCT Filed: Dec. 9, 2019
(86) PCT No.: PCT/KR2019/017318

§ 371 Date: Jun. 22, 2021

(30) Foreign Application Priority Data
Dec. 26, 2018 (KR) 10-2018-0169855

(51) Int. Cl. G05D 1/02; G01C 21/00

(52) U.S. Cl. CPC G05D 1/0276; G05D 1/0212; G01C 21/3815

(57) ABSTRACT

In the present disclosure, an electronic device and a control method thereof are provided. The electronic device for controlling driving of a vehicle of the present disclosure comprises: a sensor; a communication unit; and a processor that, when a user input for setting a destination of the vehicle is received, transmits, to an external electronic device through the communication unit, information about the destination and location information of the vehicle acquired by the sensor, receives, from the external electronic device through the communication unit, at least one road segment corresponding to a road existing in a path from the location of the vehicle to the destination thereof, from among a plurality of road segments in which map information is divided on the basis of branch points in the road, and controls driving of the vehicle on the basis of the received road segment.

### TECHNICAL FIELD

This disclosure relates to an electronic device and a control method thereof. More particularly, the disclosure relates to an electronic device controlling driving of a vehicle and a control method thereof.

### BACKGROUND ART

With an autonomous driving of a vehicle gaining a higher attention these days, research and development for a related art are under way.

An electronic device for controlling or assisting driving of a vehicle may obtain data by various sensors to recognize a location and a surrounding environment of the vehicle, and may process or analyze the obtained data in real time. However, there is a technical limitation to processing or analyzing a large amount of obtained data in real time, and there may be a problem that the reliability of the data is vulnerable, since a visible distance of sensors may be shorter than the visible distance of the eyes of a person and there may be an effect of a specific environment such as weather and a color of an object, or the like.

In order to supplement data processing and reliability of data, a technology to utilize a precision map is being developed.

The precision map may be a high-capacity map including more detailed information than a typical navigation map, and may refer to a map based on cloud (or crowdsourcing) with precision of a centimeter (cm) level.

In that the precision map is high-capacity map including a huge amount of information, it may be inefficient in terms of time and cost to store the data of an entire area in the electronic device and load the data in batches.

It is necessary to generate and manage the precision map by specific regions or sections to facilitate maintenance and repair of the precision map and improve efficiency of data processing.

However, the precision map has been generated and managed as a block type (e.g., 100 m×100 m) like a related-art navigation map, and there may be a case where a road is not present in a streamed tile, or only a portion of a road is present on a streamed map where a road is overlapped with another tile.

As described above, in case of streaming a precision map, there may be a problem in that even unnecessary data may be transmitted and received, which may cause increase in the processing amount and processing time of the data and rise in a cost. There may be a problem in that the time required for estimating the location of the vehicle or planning a behavior may be delayed due to failure in fast streaming of the necessary data, thus endangering safety.

### DISCLOSURE

### Technical Problem

It is an object of the disclosure to provide an electronic device for controlling driving of a vehicle based on a junction on a road and a control method thereof. Technical Solution

According to an embodiment, an electronic device for controlling driving of a vehicle may include a communication unit and a processor configured to, based on a user input for setting a destination of the vehicle being received, transmit, to an external electronic device through the communication unit, information about the destination and location information of the vehicle obtained by the sensor, receive, from the external electronic device through the communication unit, at least one road segment corresponding to a road existing in a path from the location of the vehicle to the destination of the vehicle, from among a plurality of road segments in which map information is divided based on a junction in the road, and control driving of the vehicle based on the received road segment.

The map information may be generated based on information obtained by a sensor provided in the vehicle while the vehicle to generate the map information drives on a road.

The processor is further configured to control driving of the vehicle based on a road segment corresponding to location information of the vehicle obtained by the sensor, among the received road segments.

The processor is further configured to, based on a plurality of road segments corresponding to the road existing in the path, receive an entirety of the plurality of road segments from the external electronic device.

The processor is further configured to, based on a plurality of road segments corresponding to the road existing in the path, receive, from the external electronic device, a part of a road segment among the plurality of road segments based on location information of the vehicle, and receive, from the external electronic device, remaining road segments while the vehicle is driving based on the received road segment.

The processor is further configured to transmit, to the external electronic device, location information of the vehicle obtained by the sensor while the vehicle is driving based on the received road segment, and receive, from the external electronic device, the remaining road segments based on the location information of the vehicle.

The processor is further configured to, based on a junction in the road existing in the path, receive, from the external electronic device, a plurality of segments corresponding to the road existing in the path and at least one road segment corresponding to a road, not present in the path, that is connected to the junction.

The at least one road segment corresponding to the road connected to the junction may be a road segment corresponding to a road from the junction to a next junction, not present in the path, among the roads connected to the junction.

Each of the plurality of road segments may include a first road segment and a second road segment generated based on a direction of driving of a vehicle between two junctions, and the processor may receive, from the external electronic device, the at least one segment determined based on the direction in which the vehicle travels along the path, between the first road segment and the second road segment.

A method of controlling driving of a vehicle may include, based on a user input for setting a destination of the vehicle being received, transmitting, to an external electronic device, information about the destination and location information of the vehicle; receiving, from the external electronic device, at least one road segment corresponding to a road existing in a path from the location of the vehicle to the destination of the vehicle, from among a plurality of road segments in which map information is divided based on junctions in the road; and controlling driving of the vehicle based on the received road segment.

The map information may be generated based on information obtained by a sensor provided in the vehicle while the vehicle to generate the map information drives on a road.

The controlling may include controlling driving of the vehicle based on a road segment corresponding to location information of the vehicle, among the received road segments.

The receiving may include, based on a plurality of road segments corresponding to a road existing in the path, receiving an entirety of the plurality of road segments from the external electronic device.

The receiving may include, based on a plurality of road segments corresponding to the road existing in the path, receiving, from the external electronic device, a part of a road segment among the plurality of road segments based on location information of the vehicle, and receiving, from the external electronic device, remaining road segments while the vehicle is driving based on the received road segment.

The receiving may include transmitting, to the external electronic device, location information of the vehicle while the vehicle is driving based on the received road segment, and receiving, from the external electronic device, the remaining road segments based on the location information of the vehicle.

The receiving may include, based on a junction in the road existing in the path, receiving, from the external electronic device, a plurality of segments corresponding to the road existing in the path and at least one road segment corresponding to a road, not present in the path, that is connected to the junction.

The at least one road segment corresponding to the road connected to the junction may be a road segment corresponding to a road from the junction to a next junction, not present in the path, among the roads connected to the junction.

The each of the plurality of road segments may include a first road segment and a second road segment generated based on a direction of driving of a vehicle between two junctions, and the receiving may include receiving, from the external electronic device, the at least one segment determined based on the direction in which the vehicle travels along the path, between the first road segment and the second road segment. Effect of Invention

According to various embodiments, an electronic device for controlling or assisting driving of a vehicle based on a road junction and a control method thereof may be provided.

By providing a road segment based on the junction of a road, receiving unnecessary data may be prevented and a calculation amount of a processor may be reduced. Accordingly, a current location of a vehicle on a map may be estimated more accurately, and reliability may be secured such that a vehicle may be driven to a destination safely.

### DESCRIPTION OF DRAWINGS

FIG. 1 is a diagram illustrating an electronic device according to an embodiment;

FIG. 2 is a block diagram of an external electronic device according to an embodiment;

FIG. 2A is a diagram illustrating a method to generate a road segment according to an embodiment;

FIG. 2B is a diagram illustrating a method to generate a road segment according to an embodiment;

FIG. 2C is a diagram illustrating a method to generate a road segment according to an embodiment;

FIG. 2D is a diagram illustrating a method to generate a road segment according to an embodiment;

FIG. 2E is a diagram illustrating a method to generate a road segment according to an embodiment;

FIG. 3 is a block diagram of an electronic device according to an embodiment;

FIG. 4 is a diagram illustrating a method for receiving a road segment according to an embodiment;

FIG. 5 is a diagram illustrating a method for receiving a road segment according to an embodiment;

FIG. 6 is a diagram illustrating a method for receiving a road segment according to an embodiment;

FIG. 7 is a diagram illustrating a method for receiving a road segment according to an embodiment;

FIG. 8 is a block diagram illustrating a detailed configuration of an electronic device in detail according to an embodiment; and

FIG. 9 is a diagram illustrating a flowchart according to an embodiment.

### MODE FOR CARRYING OUT THE INVENTION

In describing the disclosure, a detailed description of known functions or configurations incorporated herein will be omitted as it may make the subject matter of the present disclosure unclear. In addition, the embodiments described below may be modified in various different forms, and the scope of the technical concept of the disclosure is not limited to the following embodiments. Rather, these embodiments are provided so that this disclosure will be thorough and complete, and will fully convey the scope of the disclosure to those skilled in the art.

However, this disclosure is not intended to limit the embodiments described herein but includes various modifications, equivalents, and/or alternatives. In the context of the description of the drawings, like reference numerals may be used for similar components.

In addition, expressions “first”, “second”, or the like, used in the disclosure may indicate various components regardless of a sequence and/or importance of the components, will be used only in order to distinguish one component from the other components, and do not limit the corresponding components.

The expressions “A or B,” “at least one of A and/or B,” or “one or more of A and/or B,” and the like include all possible combinations of the listed items. For example, “A or B,” “at least one of A and B,” or “at least one of A or B” includes (1) at least one A, (2) at least one B, (3) at least one A and at least one B all together.

A singular expression includes a plural expression, unless otherwise specified. It is to be understood that the terms such as “comprise” or “consist of” are used herein to designate a presence of a characteristic, number, step, operation, element, component, or a combination thereof, and not to preclude a presence or a possibility of adding one or more of other characteristics, numbers, steps, operations, elements, components or a combination thereof

It is to be understood that an element (e.g., a first element) is “operatively or communicatively coupled with/to” another element (e.g., a second element) is that any such element may be directly connected to the other element or may be connected via another element (e.g., a third element). On the other hand, when an element (e.g., a first element) is “directly connected” or “directly accessed” to another element (e.g., a second element), it can be understood that there is no other element (e.g., a third element) between the other elements.

Herein, the expression “configured to” can be used interchangeably with, for example, “suitable for,” “having the capacity to,” “designed to,” “adapted to,” “made to,” or “capable of” The expression “configured to” does not necessarily mean “specifically designed to” in a hardware sense. Instead, under some circumstances, “a device configured to” may indicate that such a device can perform an action along with another device or part. For example, the expression “a processor configured to perform A, B, and C” may indicate an exclusive processor (e.g., an embedded processor) to perform the corresponding action, or a generic-purpose processor (e.g., a central processor (CPU) or application processor (AP)) that can perform the corresponding actions by executing one or more software programs stored in the memory device.

Embodiments of the disclosure will now be described in detail with reference to the attached drawings.

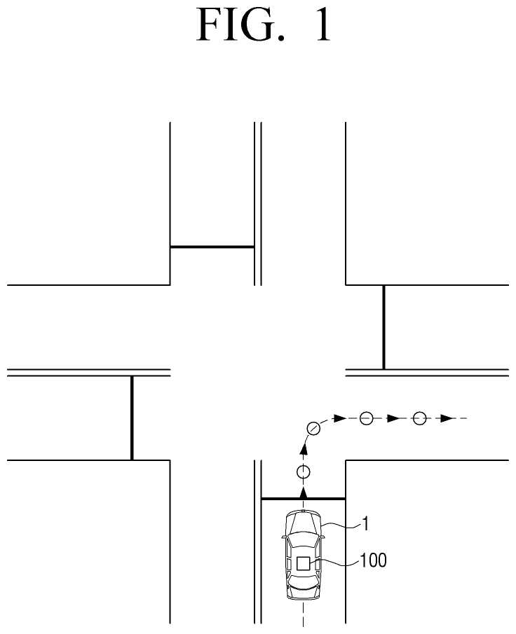

FIG. 1 is a diagram illustrating an electronic device according to an embodiment.

Referring to FIG. 1, an electronic device 100 may control or assist driving of a vehicle 1.

The electronic device 100 may be applied to an autonomous driving system or an advanced driver assistance system (ADAS). The autonomous driving system may refer to an apparatus (or a method) for controlling a vehicle to operate without manipulation of a driver by replacing the driver, and at this time, the electronic device 100 (or method) for controlling driving of the vehicle 1 may be defined as an autonomous driving system. The ADAS may refer to an apparatus (or a method) for assisting a vehicle so as to assist the driver while minimizing the driver s manipulation by assisting the driver, and at this time, the electronic device 100 (or method) for assisting driving of the vehicle 1 may be defined as the ADAS. The electronic device 100 may be applied to a vehicle for collecting data for generating a precision map (or road segment).

In that the electronic device 100 may be applicable to both the autonomous driving system or the ADAS, controlling the driving of the vehicle 1 may be defined to include assisting driving of the vehicle 1.

The vehicle 1 may include an engine (not shown), a throttle unit (not shown), a steering unit (not shown), a brake unit (not shown), or the like. The vehicle 1 may refer to a moving means capable of traveling and may be implemented as a car, a motorcycle, or the like. The embodiment is not limited thereto and may be implemented as various mobile means such as a robot, a train, a flight vehicle, or the like.

The engine may be any combination between an internal combustion engine, an electric motor, a steam engine, and a Stirling engine. For example, if the vehicle 1 is a gas-electric hybrid car, the engine may be a gasoline engine and an electric motor. For example, the engine may supply power for driving the vehicle 1 to a predetermined driving path.

The throttle unit may be a combination of mechanisms configured to control the speed of the vehicle 1 by controlling the operating speed of the engine. For example, the throttle unit may adjust the amount of mixed gas of the fuel air introduced into the engine according to the amount of opening of the throttle unit, and may control the power of the engine.

The steering unit may be a combination of mechanisms configured to adjust a direction of the vehicle 1. For example, when the steering unit is a handle, the direction of the vehicle 1 may be changed by rotating the handle in a clockwise direction or a counterclockwise direction.

The brake unit may be a combination of mechanisms configured to decelerate speed of the vehicle 1. For example, the brake unit may use friction of a wheel/tire.

The electronic device 100 is an electronic device capable of moving, such as a smartphone, a wearable device, a tablet personal computer (PC), a laptop PC, or the like, and may be implemented as a device separate from the vehicle 1. The embodiment is merely exemplary, and the electronic device 100 may be implemented as a device provided inside or outside the vehicle 1.

The electronic device 100 may control driving of the vehicle 1 based on the map information.

The electronic device 100 may estimate the location of the vehicle 1 on the map based on the location information (localization), may perceive surrounding environment of the vehicle 1 (perception), may plan behavior of the vehicle 1 according to the location and surrounding environment of the vehicle 1 (planning), and may control speed, braking, and steering of the vehicle 1 according to the planned behavior (control).

The electronic device 100 may estimate the location of the vehicle 1 based on the location information of the vehicle 1 acquired by the sensor and map information received from an external electronic device (localization). The external electronic device may be implemented as a server, or the like, providing services such as a cloud service, a map information-related service, crowd sourcing, or the like. The contents of the external electronic device will be described in more detail below.

The map information may include information on a road and surrounding environment of the road required for driving of the vehicle 1. For example, the map information may be implemented as the precision map within an error range of 1 to 100 cm.

For example, the map information may include information about the road such as length, direction, height, curvature, traffic lane (e.g., solid line, dotted line, central line, stop line, or the like), and may include information about surrounding environment of the road such as a traffic light, a road sign, a landmark, or the like, present around the road. The information about the road and the surrounding environment of the road may be implemented as a two-dimensional image, a three-dimensional image (e.g., a rendering image, a feature point, a point cloud, etc.), or the like.

The map information may be generated based on information obtained by a sensor provided in the vehicle while the vehicle to generate the map information is driving on the road.

When the pose information generated based on the information obtained by the sensor provided in the vehicle while the vehicle to generate the map information is driving on the road is transmitted to an external device, the external electronic device may generate map information using the crowdsourcing. The information obtained by the sensor provided in the vehicle may include at least one of the location information and the measurement information, which will be described later. The pose information may include an edge connecting a node to be described later and a node adjacent to the node.

The electronic device 100 may obtain location information of the vehicle 1 by various sensors, such as a global positioning system (GPS), an inertial measurement unit (IMU), or the like. The location information is information for estimating the location of the vehicle 1, and may include a geographic location (or geographic coordinate), a moving speed (or rotational speed), a moving direction (or rotational direction), an azimuth, and the like, of the vehicle 1 in the real space of the vehicle 1.

The electronic device 100 may estimate the location on the map corresponding to the current location of the vehicle 1 by matching the map information and the location information acquired by the sensor. The map information may include location on the map and location information matched with the location on the map. The location information may be used to generate map information.

The electronic device 100 may obtain measurement information by a sensor such as RAdio Detection And Ranging (RADAR), Light Detection And Ranging (LiDAR), a camera, an ultrasonic sensor, and the like. The measurement information is information for estimating the location of the vehicle 1 or recognizing the surrounding environment of the vehicle 1, and may include a distance between the vehicle 1 and the object, an appearance of the object, a shape of the object, and a size of the object, wherein the object may refer to everything within a predetermined radius based on the location of the vehicle 1, such as an obstacle, another vehicle, a landmark, a traffic light, a road sign, and the like.

The measurement information may be used to generate map information.

As an embodiment, the electronic device 100 may estimate a location of the vehicle 1 on the map by matching the measurement information obtained by a sensor and map information using trilateration (or triangulation), or the like.

For example, the electronic device 100 may measure a distance between the vehicle 1 and the three objects (e.g., landmarks) by the sensor, determine a second location (an arc of a circle) that is spaced apart by a distance (the radius of the circle) on a map corresponding to the measured distance from a first position (the center of the circle) of the three objects on the map included in the map information, and estimate a location (intersection of the three circles) where all the second positions overlap as the location on the map of the vehicle 1.

The electronic device 100 may perceive surrounding environment of the vehicle 1 based on the measurement information obtained by the sensor(perception).

For example, the electronic device 100 may recognize the surrounding environment of the vehicle 1, such as the length of the road, the direction of the road, the height of the road, the curvature of the road, the lane of the road (e.g., solid line, dotted line, central line, stop line, etc.), traffic light, sign, landmark, or the like, based on the measurement information obtained by the sensor.

This is merely exemplary, and the electronic device 100 may receive measurement information corresponding to the location of the vehicle 1 from various external electronic devices such as a traffic light, a server, another vehicle, or the like, or may recognize a surrounding environment of the vehicle 1 based on map information corresponding to the estimated location when the location of the vehicle 1 on the map 1 is estimated.

The electronic device 100 may plan a behavior of the vehicle 1 according to a location on the map and surrounding environment of the vehicle 1 (planning), and may control driving of the vehicle 1 according to the planned behavior (control).

The electronic device 100 may plan the behavior of the vehicle 1, such as the steering of the vehicle 1, the speed of the vehicle 1, the braking of the vehicle 1, and the like, depending on the location on the map, destination, and surrounding environment of the vehicle 1 based on deep learning.

The deep learning may, if information about the location on the map, destination, surrounding environment, and driving method of the drivers of the vehicle 1 is input, mean artificial intelligence which is designed so that a machine learns according to input information and plans the behavior of the vehicle 1.

The electronic device 100 may control driving of the vehicle 1 by controlling a throttle unit, a steering unit, a brake unit, or the like, of the vehicle 1 according to the planned behavior.

For driving of the vehicle 1, the electronic device 100 may receive, from an external electronic device, road segments in which map information is divided based on a junction of the road.

The external electronic device may generate map information based on information obtained by a sensor provided in a vehicle driving on a road, and may divide the map information based on a junction of a road to generate a plurality of road segments. Here, the road segment may include information about road and road surrounding environments that connect adjacent junctions.

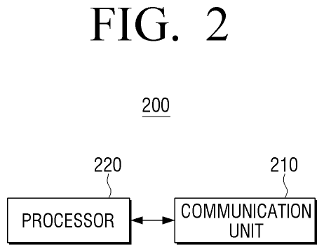

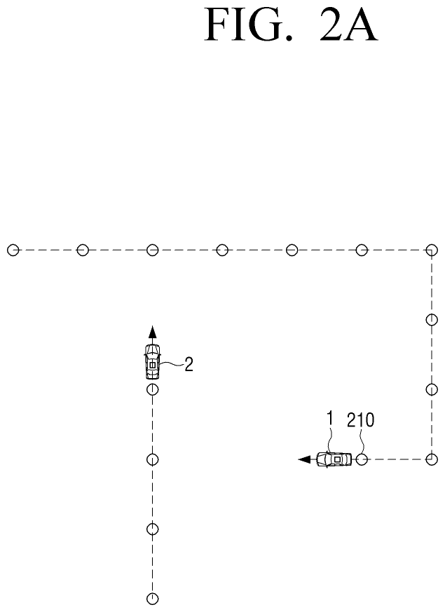

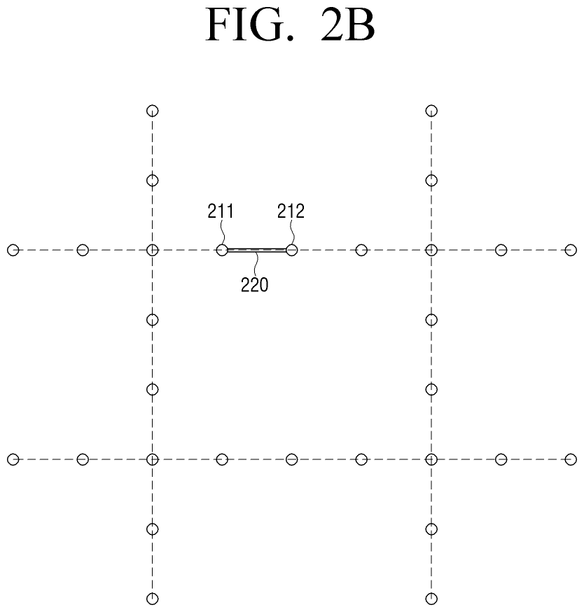

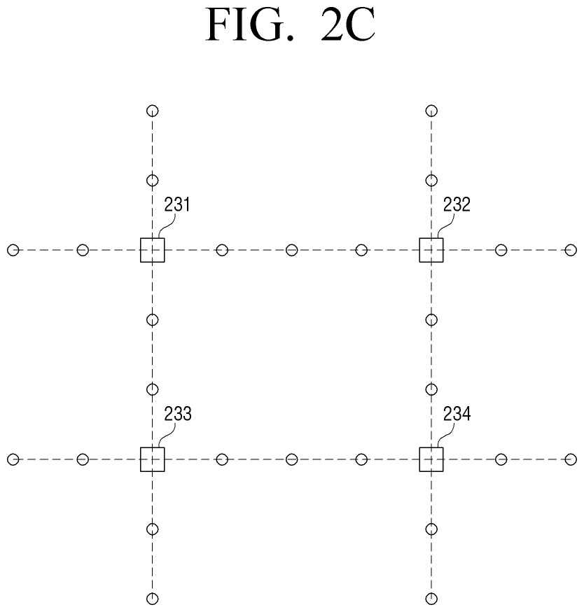

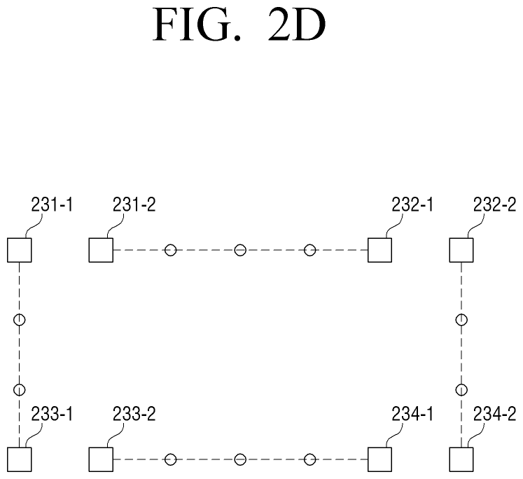

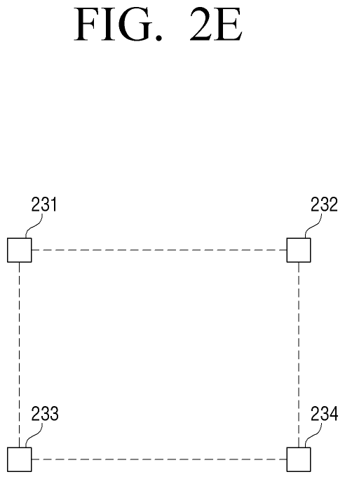

Referring to FIG. 2, a configuration of the external electronic device will be described first and then, referring to FIGS. 2A to 2E, a method of generating a road segment by the external electronic device will be described in detail.

FIG. 2 is a block diagram of an external electronic device according to an embodiment.

Referring to FIG. 2, an external electronic device 200 may include a communication unit 210 and a processor 220. The external electronic device 200 may receive information obtained by a sensor provided in the vehicle for generating map information, generate (or update) the road segment based on the received information, and provide the generated (or updated) road segment to the electronic device 100 or another electronic device.

The external electronic device 200 may be implemented as a server system composed of a single server or a plurality of servers that may provide a map service using crowdsourcing or the like. For example, the external electronic device 200 may be implemented as a cloud server that provides a virtualized information technology (IT) resource via the Internet, an edge server that simplifies the path of data in a manner that processes data in real time at a distance close to a location where data is generated, or a combination thereof

The communication unit 210 may transmit or receive various types of information by communicating with various types of external devices such as the electronic device 100, the vehicle 1, another vehicle or electronic device, a vehicle for generating map information, or the like.

For this, communication unit 210 may include at least one of the optical communication module, Ethernet module, or universal serial bus (USB) to perform the wired communication. The communication unit 210, to perform wireless communication, may include a wireless communication chip, Bluetooth chip, Wi-Fi chip, NFC chip, etc.

for wireless communication according to communication standards such as radio-frequency identification (RFID), Wireless Local Area Network (WLAN), global system for mobile communication (GSM), 3^{rd} generation (3G), 4^{th} generation (4G) (including LTE, etc.), 5^{th} generation (5G), or the like.

The processor 220 may control overall operations of the electronic device 200.

When information about the location and information about destination of the vehicle 1 is received from the electronic device 100 through the communication unit 210, the processor 220 may control the communication unit 210 to transmit, to the electronic device 100, at least one road segment corresponding to the road existing in the path from the location of the vehicle 1 to the destination of the vehicle 1, among a plurality of road segments in which the map information is segmented based on the junction of the road.

The processor 220 may generate map information based on information obtained by a sensor provided in the vehicle while the vehicle for generating map information drives on the road, and may generate a road segment by segmenting the map information based on a junction of the road.

The processor 220 may receive pose information generated during driving of the vehicle on the road, from the vehicle to generate the map information through the communication unit 210, to generate the map information.

The vehicle for generating map information may generate pose information based on information obtained by a sensor provided in the vehicle while the vehicle drives a road. In this example, a description of the sensor and the information obtained by the sensor may be applied in the same manner. The sensor provided in the vehicle may obtain location information or measurement information, may be provided inside the vehicle or attached to the outside of the vehicle, and may be implemented to be separated from the vehicle and independently perform an operation. The vehicle for generating map information may include a communication unit to perform communication with the external electronic device 200, or the like, and the same description about the above communication unit 210 may be applicable.

The pose information may include the node generated by the vehicle and an edge connecting and the node and the adjacent node.

The node may be generated every predetermined time based on the information obtained by the sensor provided in the vehicle while the vehicle drives on the road by the vehicle to generate map information. The node may refer to a specific location on the road on which the vehicle may drive and may be used to generate map information including a road (e.g., two-dimensional or three-dimensional) capable of driving by a vehicle by connecting a plurality of nodes (e.g., one-dimensional).

The node may include the location information of the node indicating the location of the node (e.g., 6 DoF (x, y, z, roll, pitch, yaw), or the like) and information about the surrounding environment of the node. For example, the location information of the node may be location information corresponding to a time when the node is generated, among the location information of the vehicle obtained by the sensor provided in the vehicle, and the information on the surrounding environment of the node may be measurement information corresponding to the time when the node is generated, among the measurement information of the vehicle obtained by the sensor provided in the vehicle.

Referring to FIG. 2A, it is assumed that a vehicle for generating map information drives on the road in a direction of an arrow. In this example, the vehicle for generating map information may refer to a separate vehicle 2 different from the vehicle 1 according to an embodiment, but the vehicle 1 may also be a vehicle for generating map information.

In this example, it is assumed that the vehicle 1 generates a node every predetermined time (e.g., 1 second) during a time when the vehicle 1 drives on a road, and a node 210 is generated by the vehicle 1 at 11 seconds. Based on the information obtained by the sensor provided in the vehicle 1, the time when the node 210 is generated may be 11 seconds, the location of the vehicle obtained at the time when the node is generated may be the location of the node, and information on the measurement of the vehicle obtained at the time of generating the node may be information about the surrounding environment of the node (e.g., image, feature point, etc.).

This is merely exemplary, and the vehicle 1 may generate a node every predetermined distance (e.g., 10 m) during the driving of the vehicle 1 on the road.

The edge may be generated by vectorising between the node by the vehicle to generate map information.

The edge may include a relative distance, direction, and error value between two nodes based on location information included in each of the two nodes, and may be used to correct location information of each of the sequentially generated nodes to minimize an error value. For example, assuming that the location information of each of the first node and the second node is 6DoF(x, y, z, roll, pitch, yaw), the error value may be implemented as a covariance matrix of 6 x 6 consisting of covariance representing the correlation of location information of each of the first node and the second node, and in this example, the vehicle or the external electronic device may correct the location information of each of the first node and the second node such that the error value is minimized by using the covariance matrix. However, this is merely exemplary, and the error value may be implemented as various statistical models.

Referring to FIG. 2B, according to an embodiment, the vehicle for generating map information may generate an edge 220 by connecting a first node 211 generated at a specific point of time t and a second node 212 generated at a next point of time t+1 by a vector.

This is merely an example, and the processor 220 may receive a plurality of nodes from a vehicle for generating map information and connect between the first node 211 generated at a particular point of time among the received plurality of nodes and the second node 212 generated at the next time t+1 to generate the edge 220.

The processor 220, based on receiving pose information from the vehicle to generate the map information through the communication unit 210, may generate the map information using the crowd sourcing method based on the received pose information.

When the processor 220 receives the pose information from the plurality of vehicles for generating map information through the communication unit 210, the processor 220 may generate map information including the node and the edge in which the location is corrected using various statistical techniques based on the received pose information. The map information may further include the location information of the node and the information about the surrounding environment of the node.

The processor 220 may generate the road segment by dividing (or segmenting) the map information based on the junction of the road.

The processor 220 may plan a junction of a road from among the plurality of nodes based on the map information. In this example, the junction may refer to a point at which the road is branched into several sections, and may refer to a point (cross-section) where the road is crossed, but hereinafter, the junction may refer to a location on the map corresponding to the point where the road is crossed, among the map information.

The processor 220 may identify a direction of a road in which a vehicle corresponding to each of the plurality of nodes may drive based on information on the surrounding environment of the node included in the map information, and may plan a node corresponding to a junction among the plurality of nodes according to the direction of the road. However, this is merely an example, and the processor 220 may plan a node at which an edge greater than or equal to a predetermined value (e.g., three) of a plurality of nodes included in the generated map information is connected (or crossed) as a node corresponding to a junction.

For example, the processor 220 may detect a traffic lane, a traffic light, etc. in an image for each surrounding environment of the plurality of nodes, identify whether the direction of the road where the vehicle may be driven may available left turn or right turn in addition to be left or right in addition to going straight, and may determine a node corresponding to the road capable of left turn or right turn corresponding to the junction.

Referring to FIG. 2C as an embodiment, the processor 220 may plan a node in which three or more edges are connected, among a plurality of nodes included in the map information, as junctions 231, 232, 233, 234 of the road.

The processor 220 may identify whether a road connecting the junctions exists based on a node and an edge included in the map information, and divide (or segment) the map information based on the junction when there is a road connecting the junctions, thereby generating the road segment.

Referring to FIGS. 2C and 2D, according to an embodiment, the processor 220 may divide the map information shown in FIG. 2C based on the road junction 231, 232, 233, and 234 and may generate a road segment corresponding to a road existing between the junctions 231-1 and 233-1 shown in FIG. 2D, a road segment corresponding to a road existing between the junctions 231-2 and 234-1, and a road segment corresponding to a road existing between the junctions 232-2 and 234-2.

For example, one of the plurality of road segments shown in FIG. 2D may include a road (or node) existing between junctions 231-1 and 233-1, a node corresponding to junctions 231-1 and 233-1, and an edge connecting each node. While the junction 231-1 and the junction 231-2 are shown as separate junctions, but this is for convenience, and the junction 231-1 and the junction 231-2 are the same as the junction 231 in FIG. 2C, and the remaining junctions are the same.

The processor 220 may connect the road segment in which the junctions are identical, among a plurality of road segments.

The processor 220 may identify the road segment having the same junction among the plurality of road segments, and may connect the same junctions with respect to the same road segments when the junctions among the plurality of road segments exist. Here, the connected road segment is referred to as a set (or macro road segment) of the road segment.

According to an embodiment, with reference to FIGS. 2D and 2E, the processor 220 may generate the set of road segments by connecting the same junctions 231, 232, 233, 234 of the four road segments having the same junction, among a plurality of road segments.

The set of road segments may include location information of each of the junctions, information about the distance between the junctions, information about a driving path, and an error value. For example, if assuming that the location of the vehicle is at the junction 231 and the destination is junction 234 as illustrated in FIG. 2E, the information about the driving path may include a path of moving to the junction 234 from the junction 231 via the junction 232, and a path of moving to the junction 234 from the junction 231 via the junction 233. In addition, the contents of the location information and the error value may be applied to the same contents as described above.

The road segment may include unique identifiers (e.g., A1, A2, . . . , B1, B2, . . . , etc.).

The processor 220 may distinguish a specific road segment among the plurality of road segments through the unique identifier assigned to the road segment, thereby transmitting a specific road segment among the plurality of road segments to the electronic device 100, and generating or managing a specific road segment among the plurality of road segments.

If the junction does not exist in the road connected to the junction (if there is only one or no junction in the road), the processor 220 may divide the map information into one road segment from the junction to a specific portion of the road where the junction does not exist.

When the processor 220 receives information obtained by the sensor provided in the vehicle for generating map information after the road segment is generated, the processor 220 may update the generated road segment based on the received information, which may be applied with the same description as that of the method for generating the road segment described above.

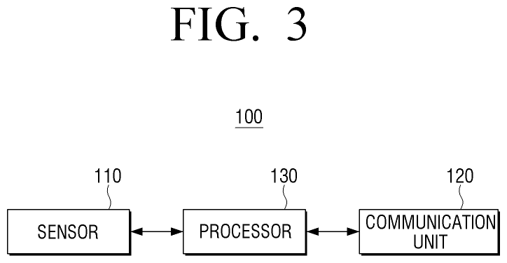

FIG. 3 is a block diagram of an electronic device according to an embodiment.

Referring to FIG. 3, the electronic device 100 for controlling driving of the vehicle 1 may include the sensor 110, the communication unit 120, and the processor 130.

In this example, the sensor 110 may include a location sensor such as a global positioning system (GPS), and in this example, the sensor 110 may communicate with artificial satellite and measure a distance between the sensor 110 and the artificial satellite to cross the distance vector, thereby obtaining information on the geographic location (x, y, z) of the vehicle 1.

The sensor 110 may include an acceleration sensor capable of measuring acceleration, a gyroscope sensor capable of measuring angular velocity, and a motion sensor such as a magnetic sensor capable of measuring magnetic force. In this case, the sensor 110 may obtain information about the location (x, y, z) and rotation (roll, pitch, yaw) of the vehicle 1 using one or a combination of an acceleration sensor, a gyroscope sensor, and a geomagnetic sensor, such as an inertial measurement unit (IMU), or the like.

The sensor 110 may sense the location of the vehicle 1 and the orientation of the vehicle 1 even when the vehicle 1 is driving a road around a high-rise building, underground, inside of a tunnel, or a road under an overpass.

The sensor 110 may include a measurement sensor such as RADAR for emitting electromagnetic waves and detecting reflected electromagnetic waves (e.g., infrared, etc.) and LiDAR for emitting laser and detecting reflected laser. In this example, the sensor 110 may measure a distance to an object existing in a surrounding environment by sensing a reflected signal by emitting an electromagnetic wave or a laser, and obtain information about a surrounding environment, such as a shape, a moving speed, and a moving direction of an object.

The sensor 110 may include a vision sensor such as a camera. In this case, the sensor 110 may obtain an image frame for the surrounding environment using the light refracted through the lens.

The sensor 110 may plan at least one pixel among a plurality of pixels in the image frame as a feature point by using a method such as Harris corner, Shi-Tomasi, SIFT-DoG, FAST, AGAST. For example, the sensor 110 may plan a pixel located on an outline as a feature point when the difference of the color value of the pixels having the outline, which represents a shape of an object, as a boundary is greater than or equal to a preset value. The sensor 110 may match the feature points planned in each of the plurality of image frames to obtain a point cloud having information on the three-dimensional coordinates (x, y, z) or distance according to the relative location variation of the matched feature points.

This is merely exemplary, and the sensor 110 may only perform operations of obtaining a plurality of image frames, and the processor 130 may plan a feature point in a plurality of image frames obtained by the sensor 110, and obtain a point cloud.

As described above, the sensor 110 may obtain location information (3DoF (x, y, yaw) or 6DoF (x, y, z, roll, pitch, yaw), etc.) of the vehicle 1 through one or a combination of a location sensor, a motion sensor, a measurement sensor, and a vision sensor, and information about a surrounding environment (e.g., information on an image frame, a feature point, a point cloud, or an object) of the vehicle 1.

The communication unit 120 may communicate with various types of external devices such as the vehicle 1, another vehicle, the external electronic device 200, a server, or the like, according to various types of communication methods to transmit and receive various types of information. The communication unit 120 may be controlled by the processor 130.

The communication unit 120, to perform wireless communication, may include a wireless communication chip, Wi-Fi chip, NFC chip, etc. for wireless communication according to communication standards such as radio-frequency identification (RFID), Wireless Local Area Network (WLAN), global system for mobile communication (GSM), 3^{rd} generation (3G), 4th generation (4G) (including LTE, etc.), 5^{th} generation (5G), or the like.

The processor 130 may control overall operations of the electronic device 100.

When a user input for setting the destination of the vehicle 1 is received, the processor 130 may transmit information on location and destination of the vehicle 1 obtained by the sensor 110 to the external electronic device 200 through the communication unit 120. The destination of the vehicle 1 may refer to a location where the vehicle 1 is to be finally reached by driving the vehicle 1.

The processor 130 may receive, from the external electronic device 200 via the communication unit 120, at least one road segment corresponding to the road present in the path from the location of the vehicle 1 to the destination of the vehicle 1, from among a plurality of road segments divided based on the junction of the road, and control driving of the vehicle 1 based on the received road segment.

The processor 130 may receive a user input to set the destination of the vehicle 1 through an interface (not shown). The interface may be an input device for receiving the operation of the user, the voice of the user, or the like, and may be implemented as a touch panel, a physical keypad (or button), an optical keypad, a microphone, or the like, provided in the electronic device 100. The interface may be an independent device separate from the electronic device 100 and may be implemented as a device such as keyboard, a mouse, an external microphone, or the like.

The embodiment is merely exemplary and may be practiced through modifications such that the processor 130 may receive a user input to set a destination of the vehicle 1 from another external electronic device 200 (e.g., smartphone, etc.) through the communication unit 120.

When a user input for setting the destination of the vehicle 1 is received, the processor 130 may transmit the location information of the vehicle 1 obtained by the sensor 110 and information on the received destination to the external electronic device 200 through the communication unit 120.

The location information of the vehicle 1 obtained by the sensor 110 may be information for estimating the location of the vehicle 1, and may include all information about the location of the vehicle 1 obtained through one or a combination of the location sensor, the motion sensor, the measurement sensor, and the vision sensor described above. For example, location information may include a geographic location (or geographic coordinate), a moving speed (or rotational speed), a moving direction (or rotational direction), an azimuth, or the like, of the vehicle 1 in the real space of the room.

When the processor 130 receives the location information of the access point from the access point fixed at a specific location, the location information of the vehicle 1 may be obtained by calculating the location of the vehicle 1 using triangulation, trilateration, etc. from the location information of the access point. As such, the location information of the vehicle 1 may include information calculated by the processor 130.

The external electronic device 200 may communicate with the electronic device 100 according to various types of communication methods to transmit and receive location information of the vehicle 1, information on a destination, a road segment, or the like.

When information on the location and destination of the vehicle 1 is received from the electronic device 100, the external electronic device 200 may transmit at least one road segment corresponding to the road existing in the path from the location of the vehicle 1 to the destination of the vehicle 1 among the plurality of road segments divided based on the junction of the road.

The map information may include information about the road and the surrounding environment of the road required for the driving of the vehicle 1. For example, the map information may be implemented as a precision map within 1-100 cm in the error range. The road segment may mean that the map information is divided (or segmented) so that the map information includes information about the road connecting adjacent junctions and the surrounding environment of the road, based on the junction (or crossroad) of the road.

The map information may be generated based on information obtained by a sensor provided in the vehicle while the vehicle for generating map information drives a road. The vehicle for generating map information may include the vehicle 1 for controlled by the electronic device 100, and another vehicle, and may generate map information for the road while driving any road using a simultaneous localization and mapping (SLAM) scheme, and at the same time, estimate the location of the vehicle.

The external electronic device 200 may plan a path from the location of the vehicle 1 to the destination of the vehicle 1 based on the received location information of the vehicle 1, information on a destination, and a path search algorithm. The path may include a junction.

The path search algorithm may be implemented as an algorithm such as A Star (A *, A Star), a Dijkstra, a Bellman-Ford, a Floyd, etc., which enables search for the shortest driving distance, and may be implemented as an algorithm for searching the shortest driving time by differently applying a weight to an edge (or an edge graph connecting a junction) connecting the nodes according to traffic information (e.g., traffic congestion, traffic accident, road damage, rain, etc.).

The external electronic device 200 may plan at least one road segment based on information on a road included in each of a plurality of road segments and information about a surrounding environment of the road, among a plurality of road segments included in the planned path, and transmit the determined road segment to the electronic device 100. The information on the road may include the length of the road, the direction of the road, the height of the road, the curvature of the road, the road lane (e.g., solid line, dotted line, central line, stop line, etc.), the road surface of the road, etc. The information on the surrounding environment of the road may include a traffic light, a sign, a landmark, an obstacle, a traffic situation, etc. existing around the road.

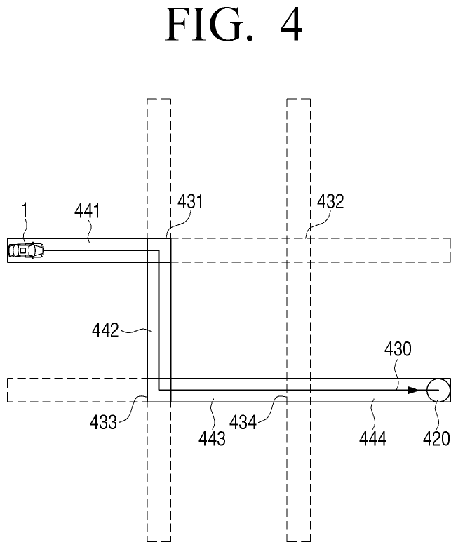

The processor 130 may receive, from the external electronic device 200 via the communication unit 120, at least one road segment corresponding to the road present in the path from the location of the vehicle 1 to the destination of the vehicle 1 from among a plurality of road segments divided based on the junction of the road. The details will be described later with reference to FIGS. 4 to 7.

The processor 130 may control the driving of the vehicle 1 based on the received road segment.

The processor 130 may estimate localization of the vehicle 1 on the road segment based on the location information of the vehicle 1 obtained by the sensor 110 and the road segment received from the external electronic device 200 (localization), and may perceive the surrounding environment of the vehicle 1 based on the measurement information obtained by the sensor 110 (perception).

The processor 130 may plan the behavior of the vehicle 1 according to the location of the vehicle 1 on the road segment and surrounding environment (planning), and may control the driving of the vehicle 1 according to the planned behavior(control).

The processor 130 may control driving of the vehicle to move along a path from a location on the road segment of the vehicle 1 to a destination on the road segment of the vehicle 1. For example, the processor 130 may control the vehicle 1 to move along a driving path by generating a signal for controlling the speed, braking, and steering of the vehicle, and forwarding the generated signal to the vehicle 1.

With reference to FIGS. 4 to 7, the road segment according to an embodiment will be described. A path from the current location to a destination 420 of the vehicle 1 is illustrated as path 430.

According to an embodiment, the processor 130, when there are a plurality of road segments corresponding to the road present in the path, may receive the entirety of the plurality of road segments from the external electronic device 200.

If there are a plurality of road segments corresponding to the road present in the path, when the processor 130 identifies that the length of the road section included in the plurality of road segments is less than a predetermined value, the processor 130 may receive the entire plurality of road segments from the external electronic device 200 through the communication unit 120. The predetermined value may be a value set by the initial or user and may be changed by the user.

For example, referring to FIG. 4, if the length of the road section (e.g., 20 km) included in the plurality of road segments 441, 442, 443, 444 is less than a preset value (e.g., 50 km), the processor 130 may receive, from the external electronic device 200 through the communication unit 120, the entirety of the plurality of road segments 441, 442, 443, 444 corresponding to the road present in the path 430 from the location of the vehicle 1 to the destination 420, among the plurality of road segments 441, 442, 443, 444 in which map information is divided based on the junctions of the road 431, 432, 433, 434.

According to another embodiment, the processor 130 may receive a portion of the plurality of road segments from the external electronic device 200 based on the location information of the vehicle 1 when there are a plurality of road segments corresponding to the road present in the path, and receive the remaining road segments from the external electronic device 200 while the vehicle is driving based on the received road segment.

When there are a plurality of road segments corresponding to the road present in the path, if it is identified that the length of the road section included in the plurality of road segments is equal to or greater than a predetermined value, the processor 130 may receive some of the plurality of road segments from the external electronic device 200 based on the location information of the vehicle 1.

The processor 130 may transmit the location information of the vehicle 1 obtained by the sensor 110 to the external electronic device 200 during driving of the vehicle 1, and receive the remaining road segments except for the received road segment from the external electronic device 200 through the communication unit 120 based on the location information of the vehicle 1.

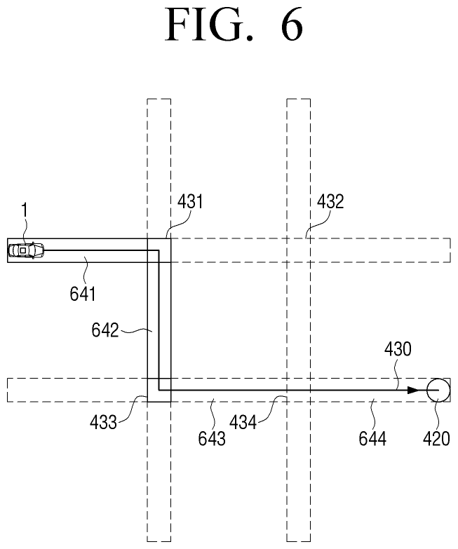

For example, with reference to FIG. 6, when the length of the road section (e.g., 100 km) included in the plurality of road segments 641, 642, 643, 644 is greater than or equal to a preset value (e.g., 50 km), the processor 130 may receive, from the external electronic device 200, some road segments 641, 642 adjacent to the location of the vehicle 1 among a plurality of road segments 641, 642, 643, 644 based on the location information of the vehicle 1. At this time, the processor 130 may receive some of the road segments 641 and 642 from the external electronic device 200 in an order close to the location of the vehicle 1. The processor 130 may transmit the location information of the vehicle 1 obtained by the sensor 110 to the external electronic device 200 during driving of the vehicle 1 based on the received road segments 641 and 642, and receive the remaining road segments 643 and 644 from the external electronic device 200 through the communication unit 120 based on the location information of the vehicle 1.

The processor 130 may transmit the location information of the vehicle 1 obtained by the sensor to the external electronic device 200 during driving of the vehicle 1 based on the received road segment, and receive the remaining road segment from the external electronic device 200 based on the location information of the vehicle 1.

The processor 130 may control the vehicle 1 to drive along a road based on information about the road included in the received road segment, and transmit the location information of the vehicle 1 obtained by the sensor 110 to the external electronic device 200 during driving of the vehicle 1.

When an event in which a driving vehicle 1 enters a road corresponding to the remaining road segments 643 and 644 occurs, the processor 130 may receive, from the external electronic device 200, the remaining road segments 643 and 644 in a road segment order corresponding to a road closest to the location of the vehicle 1, at the electronic device 100.

The event may be a case where a distance to the junction 433 included in the remaining road segments 643, 644 closest from the location of the vehicle 1 is less than a preset value, or an expected time when the vehicle 1 reaches the junction 433 included in the remaining road segments 643, 644 closest from the location of the vehicle 1 based on the speed of the vehicle 1 is less than a preset value, or the like.

According to an embodiment, as described above, the electronic device 100 may receive map information in a road segment unit, and may receive all or a portion of the road segment according to the length of the road section, thereby improving the efficiency of streaming.

According to the above-described example, it may be possible to receive a whole or part of a plurality of road segments on the basis of the length of the road in that the length of the road may be an element capable of increasing the size of the data for the road segment, but the embodiment may be modified and applied with respect to other factors such as size of the data of the road segment, communication speed related to transmission, communication state, or the like.

According to another embodiment, when a junction exists in a road present in a path, the processor 130 may receive, from the external electronic device 200, a plurality of segments corresponding to the road and present in the path and at least one road segment, though not being present in the path, corresponding to a road connected to a junction.

The at least one road segment corresponding to the road connected to the junction may be at least one road segment, among road segments corresponding to the road connecting the junction present (or included) in the path and the junction adjacent to the junction by n^{th} order (the junction not present in the path, n is the natural number).

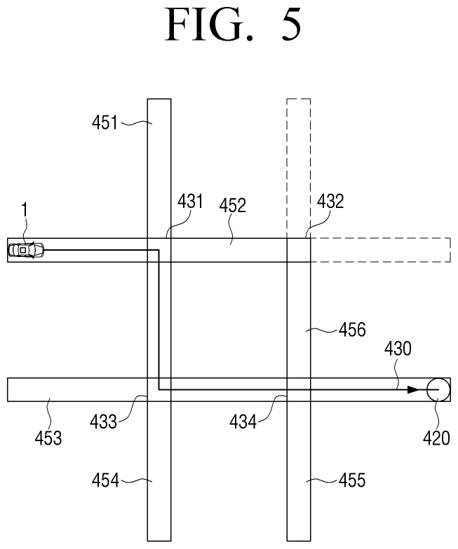

For example, when n is 1 as shown in FIG. 5, at least one road segment corresponding to a road connected to a junction may be at least one road segment among the road segments corresponding to the road connecting the junction existing in a path and a junction closest to the junction (not included in a path not included in a path).

The processor 130 may receive, from the external electronic device 200, a plurality of segments corresponding to the road present in the path 430 and at least one road segment, among road segments 451, 452, 453, 454, 455, 456 corresponding to a road connected to the junctions 331, 333, 334, not present in the path, through the communication unit 120.

At least one road segment received by the processor 130 from the external electronic device 200 may be planned by combining the contents described in the embodiment of FIGS. 4 and 6 described above. That is, at least one road segment may be entirety of the plurality of segments corresponding to the road present in the path or the entirety of the road segments corresponding to the road connected to the junction, even though not present in the path, or some road segments which are planned based on the length of the road included in the road segments among the entirety of the plurality of segments corresponding to the road present in the path and the entirety of the road segment not present in the path but connected to the junction.

The electronic device 100 may more accurately estimate the location of the vehicle 1 by using surrounding environment information included in the segment not included in the path among the road connected to the junction included in the path, as at least one road segment not present in the path, but corresponding to the road connected to the junction is received.

The electronic device 100 may receive a road segment corresponding to a road connecting a junction and a junction (a junction not present in a path) adjacent to the junction in the n^{th} order to more accurately identify a traffic condition (e.g., traffic congestion, an accident, etc.) in a road adjacent to the junction and the junction, thereby changing the path of the vehicle to drive the vehicle 1 to a destination via another road adjacent to the junction by avoiding the congested section.

According to another embodiment, the processor 130 may receive, from the external electronic device 200, at least one segment planned based on a direction where the vehicle 1 travels along the path, between the first road segment and the second road segment.

Each of the plurality of road segments may include a first road segment and a second road segment generated based on a direction of driving of the vehicle 1 between two junctions.

The first road segment and the second road segment may be distinguished according to a driving direction in which the vehicle 1 travels.

For example, if the vehicle 1 is determined to be driven to the right (or left) portion of the road on the basis of the center line of the road, the left portion of the road may be distinguished as the first road segment, and the right portion of the road may be the second road segment.

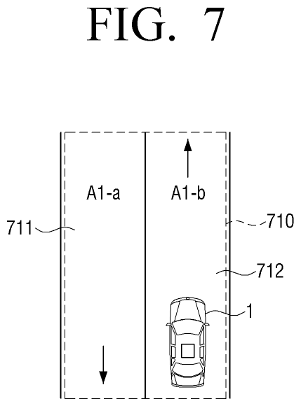

Referring to FIG. 7, the vehicle 1 may drive in a right (or left) portion of the road with respect to the central line of the road in a direction of an arrow.

In this example, a road segment 710 may include a first road segment 711 and a second road segment 712 generated based on a driving direction in which the vehicle 1 can move between two junctions. The first road segment 711 may be assigned with a unique identifier such as A1-a, the second road segment 712 may be assigned with a unique identifier such as A1-b, A1 may represent the road segment 710 and a or b may be an identifier indicating the direction.

The processor 130 may plan at least one segment 712 based on a direction in which the vehicle travels along a path from between the first road segment 711 and the second road segment 712 included in each of the plurality of road segments 710, and receive the planned segment 712 from the external electronic device 200 via the communication unit 120.

The electronic device 100 may receive any one of the first and second road segments generated by dividing the road segment according to the driving direction of the vehicle, thereby improving the efficiency and precision of transmission and processing of data through streaming in a road segment unit according to the driving direction of the vehicle.

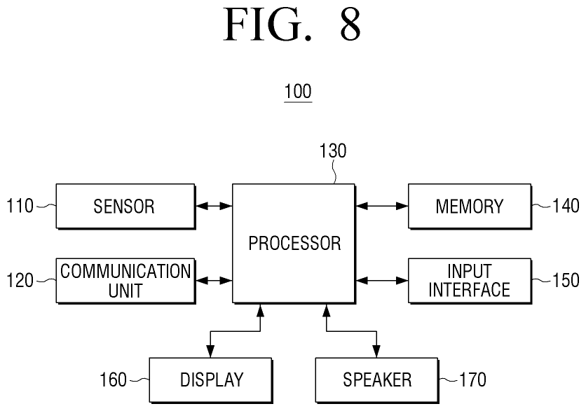

FIG. 8 is a block diagram illustrating a detailed configuration of an electronic device in detail according to an embodiment.

Referring to FIG. 8, the electronic device 100 may further include at least one of a memory 140, an input/output interface 150, a display 160, and a speaker, in addition to the sensor 110, the communication unit 120, and the processor 130.

The memory 140 may store various programs and data necessary for operating the electronic device 100. For example, the memory 140 may store the information obtained by the sensor 110, a program controlling the driving of the vehicle 1, and the received road segment.

The memory 140 may be implemented as a non-volatile memory, a volatile memory, a flash memory, a hard disk drive (HDD), a solid state drive (SSD), or the like. The memory 140 is accessed by the processor 130 and reading/writing/modifying/deleting/updating of data by the processor 130 may be performed. In the disclosure, the term memory may include the memory 140, random access memory (RAM) (not shown), read-only memory (ROM) (not shown) in the processor 130, or a memory card (not shown) (for example, a micro SD card, a memory stick, or the like) mounted to the electronic device 100.

The input interface 150 may receive various user inputs and may forward the user inputs to the processor 130.

For example, the input interface 150 may include a touch panel, a pen sensor, a key, or a microphone.

The touch panel, for example, may use one of the capacitive, reducing, infrared, or ultrasonic method. In addition, a touch panel may further include a control circuit. The touch panel further includes a tactile layer, and it is possible to provide tactile response to the user. The pen sensor may, for example, be a part of a touch panel, or may include other recognition sheets. The key, for example, may include a physical button, an optical key, or keypad. The microphone may directly obtain a signal of an audio from an external sound. For example, the microphone may convert external analog signal into a digital signal and obtain the same.

The electronic device 100 may be connected from an external input device (not shown) such as a keyboard, a mouse, or the like, by wire or wirelessly for receiving a user input or may communicate with another electronic device (not shown) such as a smartphone to receive a user input.

The display 160 may display image data processed by an image processor (not shown) in a display area (or display). The display area may mean at least a portion of the display 160 exposed on one surface of the housing of the electronic device 100.

At least a portion of the display 160 may be coupled to at least one of a front area, a side area, and a rear area of the electronic device 160 in the form of a flexible display. The flexible display may be characterized in that it may be bent, curbed, or rolled without a damage through a paper-like thin and flexible substrate.

The display 160 may be implemented as a touch screen having a layer structure in combination with a touch panel (not shown). The touch screen may have a function of detecting a location of a touch input, an area of a touch input, and a pressure of a touch input as well as a display function, and may also have a function of detecting a touch close to the touch screen (proximity touch) as well as a real-touch that is substantially in contact with the touch screen.

The speaker 170 is configured to output various audios for which various processing operations such as decoding, amplification, noise filtering, or the like, are performed by an audio processor (not shown) but also various notification sounds and a speech converted by a text to speech (TTS) algorithm as sound.

The electronic device 100 may further include an input/output port (not shown), in addition to the above configuration.

The input/output port is a configuration to connect the electronic device 100 and an external device (not shown) by wire, so that the electronic device 100 may transmit or receive an image and/or a signal about a voice and/or data with an external device (not shown). The input/output port may include a module for processing a signal transmitted or received.

For this purpose, the input/output port may be implemented as a wired port such as high-definition multimedia interface (HDMI) port, a display port, a red-green-blue (RGB) port, a digital visual interface (DVI) port, Thunderbolt, component port, or the like.

In one example, the electronic device 100 may receive the image and / or a signal of audio from the external device (not shown) through the input/output port, so that the electronic device 100 may output an image and/or a voice. In another example, the electronic device 100 may transmit a specific image and/or a signal of audio to an external device through the input/output port, so that an external device (not shown) may output the image and/or voice.

An image and/or a signal of an audio may be transmitted in a unidirectional manner through the input/output port. However, this is merely exemplary, and the image and/or a signal of an audio may be transmitted in a bidirectional manner through the input/output port.

The input/output port may include USB port (2.0, USB 3.0, USB C, etc.), secure digital (SD) card port, micro SD card port, or the like.

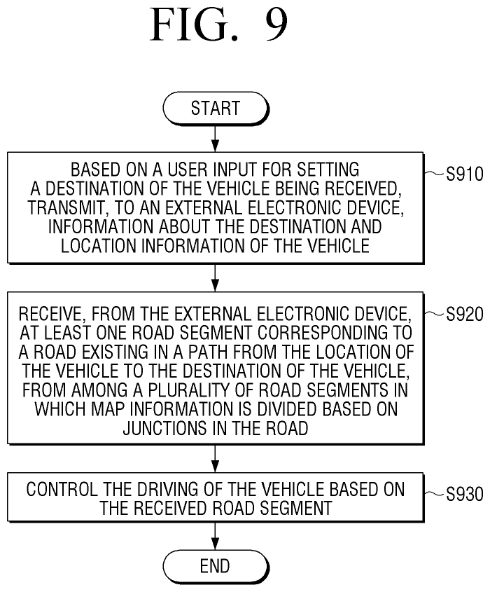

FIG. 9 is a diagram illustrating a flowchart according to an embodiment.

Referring to FIG. 9, a method of controlling driving of a vehicle may include, based on a user input for setting a destination of the vehicle being received, transmitting, to an external electronic device, information about the destination and location information of the vehicle in operation S910.

The method may include receiving, from the external electronic device, at least one road segment corresponding to a road existing in a path from the location of the vehicle to the destination of the vehicle, from among a plurality of road segments in which map information is divided based on junctions in the road in operation S920.

The map information may be generated based on information obtained by a sensor provided in the vehicle while the vehicle to generate the map information drives on a road. The map information may include information about the road and the surrounding environment of the road, which are required for driving the vehicle, and may be implemented with a precision map within an error range of 1-100 cm.

The road segment may mean that the road information is divided (or segmented) to include only the information about the road connects the adjacent junctions and the surrounding environment of the road, based on the junctions (or intersections) of the road.

The receiving may include, based on a plurality of road segments corresponding to a road existing in the path, receiving an entirety of the plurality of road segments from the external electronic device.

The receiving may include, based on a plurality of road segments corresponding to the road existing in the path, receiving, from the external electronic device, a part of a road segment among the plurality of road segments based on location information of the vehicle, and receiving, from the external electronic device, remaining road segments while the vehicle is driving based on the received road segment.

The receiving may include transmitting, to the external electronic device, location information of the vehicle while the vehicle is driving based on the received road segment, and receiving, from the external electronic device, the remaining road segments based on the location information of the vehicle.

The receiving may include, based on a junction in the road existing in the path, receiving, from the external electronic device, a plurality of segments corresponding to the road existing in the path and at least one road segment corresponding to a road, not present in the path, that is connected to the junction.

The at least one road segment corresponding to the road connected to the junction may be a road segment corresponding to a road from the junction to a next junction, not present in the path, among the roads connected to the junction.

Each of the plurality of road segments may include a first road segment and a second road segment generated based on a direction of driving of a vehicle between two junctions, and the receiving may include receiving, from the external electronic device, the at least one segment determined based on the direction in which the vehicle travels along the path, between the first road segment and the second road segment.

The driving of the vehicle may be controlled based on the received road segment in operation S930.

The controlling may include controlling driving of the vehicle based on a road segment corresponding to location information of the vehicle, among the received road segments.

Based on the road segment received from the external electronic device and the location information of the vehicle obtained by the sensor, the location on the road segment of the vehicle may be localized (localization), and the surrounding environment of the vehicle may be perceived on the basis of the measurement information obtained by the sensor (perception).

The controlling may include planning the behavior of the vehicle in accordance with the location and surrounding environment on the road segment of the vehicle (planning), and controlling the driving of the vehicle according to the planned behavior (control).

The controlling may include controlling driving of the vehicle to move along a path from a location on the road segment of the vehicle to the destination. For example, the processor 130 may control the vehicle to move along a driving path by generating a signal for controlling the speed, braking, and steering of the vehicle, and forwarding the generated signal to the vehicle.

The term “unit” or “module” used in the disclosure includes units consisting of hardware, software, or firmware, and is used interchangeably with terms such as, for example, logic, logic blocks, parts, or circuits. A “unit” or “module” may be an integrally constructed component or a minimum unit or part thereof that performs one or more functions. For example, the module may be configured as an application-specific integrated circuit (ASIC).

The embodiments of the disclosure may be implemented as software that includes instructions stored in machine-readable storage media readable by a machine (e.g., a computer). A device may call instructions from a storage medium and that is operable in accordance with the called instructions, including an electronic device (e.g., the electronic device 100). When the instruction is executed by a processor, the processor may perform the function corresponding to the instruction, either directly or under the control of the processor, using other components. The instructions may include a code generated or executed by the compiler or interpreter. The machine-readable storage medium may be provided in the form of a non-transitory storage medium. Here, “non-transitory” means that the storage medium does not include a signal and is tangible, but does not distinguish whether data is permanently or temporarily stored in a storage medium.

According to embodiments, a method disclosed herein may be provided in a computer program product. A computer program product may be traded between a seller and a purchaser as a commodity. A computer program product may be distributed in the form of a machine readable storage medium (e.g., CD-ROM) or distributed online through an application store (e.g., PlayStoreTM). In the case of on-line distribution, at least a portion of the computer program product may be stored temporarily or at least temporarily in a storage medium such as a manufacturer's server, a server in an application store, or a memory in a relay server.

Each of the components (for example, a module or a program) according to the embodiments may be composed of one or a plurality of objects, and some subcomponents of the subcomponents described above may be omitted, or other subcomponents may be further included in the embodiments. Alternatively or additionally, some components (e.g., modules or programs) may be integrated into one entity to perform the same or similar functions performed by each respective component prior to integration. Operations performed by a module, program, or other component, in accordance with the embodiments, may be performed sequentially, in a parallel, repetitive, or heuristic manner, or at least some operations may be performed in a different order, omitted, or other operations can be added.

What is claimed is:

1. An electronic device for controlling driving of a vehicle, comprising:
a sensor;
a communication unit; and
a processor configured to:
based on a user input for setting a destination of the vehicle being received, transmit, to an external electronic device through the communication unit, information about the destination and location information of the vehicle obtained by the sensor,
receive, from the external electronic device through the communication unit, at least one road segment corresponding to a road existing in a path from the location of the vehicle to the destination of the vehicle, from among a plurality of road segments in which map information is divided based on a junction in the road, and
control driving of the vehicle based on the received road segment.

2. The electronic device of claim 1, wherein the map information is generated based on information obtained by a sensor provided in the vehicle while the vehicle to generate the map information drives on a road.

3. The electronic device of claim 1, wherein the processor is further configured to control driving of the vehicle based on a road segment corresponding to location information of the vehicle obtained by the sensor, among the received road segments.

4. The electronic device of claim 1, wherein the processor is further configured to, based on a plurality of road segments corresponding to the road existing in the path, receive an entirety of the plurality of road segments from the external electronic device.

5. The electronic device of claim 1, wherein the processor is further configured to:
based on a plurality of road segments corresponding to the road existing in the path, receive, from the external electronic device, a part of a road segment among the plurality of road segments based on location information of the vehicle, and receive, from the external electronic device, remaining road segments while the vehicle is driving based on the received road segment.

6. The electronic device of claim 5, wherein the processor is further configured to transmit, to the external electronic device, location information of the vehicle obtained by the sensor while the vehicle is driving based on the received road segment, and receive, from the external electronic device, the remaining road segments based on the location information of the vehicle.

7. The electronic device of claim 1, wherein the processor is further configured to, based on a junction in the road existing in the path, receive, from the external electronic device, a plurality of segments corresponding to the road existing in the path and at least one road segment corresponding to a road, not present in the path, that is connected to the junction.

8. The electronic device of claim 7, wherein the at least one road segment corresponding to the road connected to the junction is a road segment corresponding to a road from the junction to a next junction, not present in the path, among the roads connected to the junction.

9. The electronic device of claim 1, wherein each of the plurality of road segments comprises a first road segment and a second road segment generated based on a direction of driving of a vehicle between two junctions, and
wherein the processor is further configured to receive, from the external electronic device, the at least one segment determined based on the direction in which the vehicle travels along the path, between the first road segment and the second road segment.

10. A method of controlling driving of a vehicle, the method comprising:
based on a user input for setting a destination of the vehicle being received, transmitting, to an external electronic device, information about the destination and location information of the vehicle;
receiving, from the external electronic device, at least one road segment corresponding to a road existing in a path from the location of the vehicle to the destination of the vehicle, from among a plurality of road segments in which map information is divided based on junctions in the road; and
controlling driving of the vehicle based on the received road segment.

11. The method of claim 10, wherein the map information is generated based on information obtained by a sensor provided in the vehicle while the vehicle to generate the map information drives on a road.

12. The method of claim 10, wherein the controlling comprises controlling driving of the vehicle based on a road segment corresponding to location information of the vehicle, among the received road segments.

13. The method of claim 10, wherein the receiving comprises, based on a plurality of road segments corresponding to a road existing in the path, receiving an entirety of the plurality of road segments from the external electronic device.

14. The method of claim 10, wherein the receiving comprises, based on a plurality of road segments corresponding to the road existing in the path, receiving, from the external electronic device, a part of a road segment among the plurality of road segments based on location information of the vehicle, and receiving, from the external electronic device, remaining road segments while the vehicle is driving based on the received road segment.

15. The method of claim 14, wherein the receiving comprises transmitting, to the external electronic device, location information of the vehicle while the vehicle is driving based on the received road segment, and receiving, from the external electronic device, the remaining road segments based on the location information of the vehicle.
